(19) United States
(12) Patent Application Publication
(10) Pub. No.: US 2016/0066593 A1
(43) Pub. Date: Mar. 10, 2016

(54) PROCESS FOR THE PREPARATION OF A HEAT-RESISTANT CHOCOLATE PREPARATION

(71) Applicant: DUPONT NUTRITION BIOSCIENCES APS, Copenhagen K (DK)

(72) Inventors: JENS MOGENS NIELSEN, Galten (DK); SUSANNE BUDDE LUND, Randers NØ (DK); EVA LYNENSKJOLD, Randers NØ (DK); MAJBRIT DORA LAURSEN, Bjerringbro (DK)

(21) Appl. No.: 14/888,149

(22) PCT Filed: May 1, 2014
(86) PCT No.: PCT/IB2014/061134

§ 371 Date: Oct. 30, 2015

(30) Foreign Application Priority Data
May 2, 2013 (GB) 1307951.2

(51) Int. Cl. A23G 1/00; A23G 1/36

(52) U.S. Cl. CPC A23G 1/0036; A23G 1/36; A23G 1/0069; A23V 2002/00

(57) ABSTRACT

The present invention relates a process for the preparation of a chocolate composition, the process comprising the steps of preparing a blend of dry ingredients, each ingredient having an individual fat content of less than 30%; conching the blend of dry ingredients; adding one or more ingredients having an individual fat content of 30% fat or greater to the blend and mixing; and compressing the mixture of step iii) to form the chocolate composition.

### FIELD OF THE INVENTION

The present invention relates to a process for the preparation of a chocolate composition, a chocolate composition obtained or obtainable by said process, and packaged chocolate compositions.

### BACKGROUND TO THE INVENTION

Chocolate is a popular confectionary foodstuff throughout the world. It is produced from the cocoa bean and can comprise a number of additional ingredients such as sugar and milk-derived ingredients.

Cocoa butter and cocoa solids are important products of the cocoa bean used in chocolate manufacture. They each impart important characteristics to the final chocolate and so their respective quantities are often varied to produce different types of chocolate.

For example, cocoa solids typically have a brown colour and therefore have a major influence on the colour of the final chocolate. For example, white chocolate contains essentially no cocoa solids, whereas dark chocolate (sometimes referred to as “sweet chocolate”) contains a higher proportion of cocoa solids. Further, milk chocolate contains milk-derived fat in addition to the fat present in the form of cocoa butter.

Cocoa butter is an extremely important constituent in traditional chocolate as its melting point, around 35 to 36.5° C., is very close to body temperature. This has the advantageous effect that the cocoa butter containing chocolate is generally solid at temperatures below body temperature, i.e. ambient temperature, and therefore is conveniently stored, yet at elevated temperatures such as in the mouth of a consumer, it begins to melt. This melt-in-the-mouth profile is distinctive of chocolate and contributes significantly to the eating pleasure.

However, as a result of this sensitivity to temperature change, the storage of chocolate at temperatures near to its melting point can be problematic. As a result, the quality of chocolate can deteriorate dramatically unless conditions are well controlled.

As well as the actual melting point of cocoa butter being problematic, traditional processes of preparing chocolate actually exacerbate the issue. A traditional process for preparing chocolate may include the following steps:
dry blending milk-derived ingredients, sugar, cocoa solids and cocoa butter;
refining the blend, whereby the particle size of the various solids in the blend are reduced;
conching, whereby the refining process is continued at an elevated temperature;
tempering, whereby the chocolate is processed to ensure that it crystalizes in a desired form;
shaping, cooling, and packaging etc.

As a result of this process, the cocoa butter and any other fat components become continuously dispersed throughout the chocolate. The structure of the chocolate therefore becomes highly dependent on the stability of the dispersed fat. When the fat melts, the chocolate becomes greasy and its structure can become compromised. When this occurs during storage, the chocolate may subsequently be deemed by consumers unsuitable for consumption.

Production of temperature tolerant chocolate would allow production of chocolate-containing foodstuffs that are more suitable for hot climates, particularly in less economically developed countries where the supply chain is ill-equipped to handle significant temperature/humidity fluctuations and where product quality is compromised as a result.

A number of attempts have been made to produce chocolate that is temperature tolerant (heat stable).

U.S. Pat. No. 4,081,559 discloses a process for manufacturing a shaped heat-resistant edible chocolate product comprising the steps of (i) thoroughly mixing at least the following ingredients: water, 15% to 35% by weight of at least one edible fat selected from (a) cocoa butter and (b) cocoa butter and at least one other fat, and not less than 40% by weight of sugar said percentage being based on the total weight of the chocolate product, so as to produce an aqueous sugar solution in which said at least one edible fat is emulsified with the solution, (ii) maintaining said at least one edible fat emulsified with the aqueous sugar solution, evaporating sufficient water from the solution to prevent separation of said at least one edible fat from the said solution, (iii) shaping the resultant evaporating mixture and (iv) drying the shaped mixture so as to produce a shaped heat-resistant chocolate product having a moisture content of not more than 5% by weight and such that individual particles of said at least one edible fat are encapsulated in a sugar glass. The aims of this process are to encapsulate the fat in the sugar, therefore ensuring that the fat is not dispersed continuously throughout the foodstuff and imparting heat resistance to the chocolate product.

Alternatively, WO 2010/148058 discloses a temperature resistant chocolate composition including a solid material (e.g., typically a nutritive carbohydrate sweetener such as but not limited to, sucrose) which contains at least about 1% by weight of the chocolate composition having a particle size ranging from about 50 to about 1,000 nanometers.

The present invention seeks to provide an improved process for preparing a chocolate composition and a chocolate composition obtainable from that process.

### SUMMARY OF THE INVENTION

In one aspect the present invention provides a process for the preparation of a chocolate composition, the process comprising the steps of:
i) preparing a blend of dry ingredients, each ingredient having an individual fat content of less than 30%;
ii) conching the blend of dry ingredients;
iii) adding one or more ingredients having an individual fat content of 30% fat or greater to the blend and mixing; and
iv) compressing the mixture of step iii) to form the chocolate composition.

In another aspect the present invention provides a chocolate composition obtained or obtainable by the process of the present invention.

In another aspect the present invention provides a chocolate composition prepared by:
i) preparing a blend of dry ingredients, each ingredient having an individual fat content of less than 30%;
ii) conching the blend of dry ingredients;
iii) adding one or more ingredients having an individual fat content of 30% fat or greater to the blend and mixing; and
iv) compressing the mixture of step iii) to form the chocolate composition.

These and other aspects of the present invention will now be explained in more detail. In this regard, the particular features mentioned with respect to each aspect are not necessarily limited to that aspect and may be combined with other features of the same or other aspects as will be appreciated by one skilled in the art.

### DETAILED DESCRIPTION

In one aspect the present invention provides a process for the preparation of a chocolate composition, the process comprising the steps of:
i) preparing a blend of dry ingredients, each ingredient having an individual fat content of less than 30%;
ii) conching the blend of dry ingredients;
iii) adding one or more ingredients having an individual fat content of 30% fat or greater to the blend and mixing; and
iv) compressing the mixture of step iii) to form the chocolate composition.

A “chocolate composition” is defined herein as a solid or substantially-solid foodstuff comprising at least one of cocoa solids or cocoa butter (or a substitute or replacer thereof).

In this regard, some or all of the cocoa butter in a chocolate composition may be replaced by cocoa butter substitutes (CBS, also known as cocoa butter replacers). Compositions containing predominantly cocoa butter substitutes are often known as “compound chocolates”.

Thus, the “chocolate composition” of the present invention encompasses both chocolate and chocolate compound.

In one embodiment, the chocolate composition comprises cocoa solids and cocoa butter. In one embodiment, the chocolate composition comprises cocoa solids, cocoa butter and cocoa butter substitutes. In one embodiment, the chocolate composition comprises cocoa solids and cocoa butter substitutes. In one embodiment, the chocolate composition comprises cocoa butter and cocoa butter substitutes.

The process of the present invention includes the step of preparing a blend of dry ingredients. The term “dry ingredients” in the context of the present invention refers to ingredients that are substantially free of water. For example, such ingredients typically have a water content of less than 4%.

The ingredients of step i) are also required to have an individual fat content of less than about 30%. Thus, each ingredient used in step i) has a fat content of less than about 30%. In one embodiment, the ingredients of step i) each have a fat content of less than about 28%. In one embodiment, the ingredients of step i) each have a fat content of less than about 26%. In one embodiment, the ingredients of step i) each have a fat content of less than about 20%. In one embodiment, the ingredients of step i) each have a fat content of less than about 15%. In one embodiment, the ingredients of step i) each have a fat content of less than about 12%.

Exemplary dry ingredients with the required fat content for use in step i) include, but are not limited to cocoa solids, dairy powders, sweeteners, emulsifiers, milk-solids-non-fats (MSNF), flavourings, preservatives, and other excipients such as hydrocolloids.

In one embodiment, the dry ingredients of step i) are selected from cocoa solids, sweeteners, emulsifiers, dairy powder, non-fat dairy solids, flavourings, preservatives, and other excipients such as hydrocolloids etc.

In one embodiment, the dry ingredients of step i) are selected from at least cocoa solids and sweeteners.

The cocoa solids contain a low proportion of fat. In one embodiment, the cocoa solids are considered to be reduced fat cocoa solids and contain less than 20% fat. In one embodiment, the reduced fat cocoa solids contain less than 15% fat. In one embodiment, the reduced fat cocoa solids contain less than 12% fat. In one embodiment, the reduced fat cocoa solids contain 10 to 15% fat. In one embodiment, the reduced fat cocoa solids contain 10 to 12% fat.

In one embodiment, the chocolate composition of the present invention comprises at least 30% cocoa solids. In one embodiment, the chocolate composition of the present invention comprises at least 25% cocoa solids. In one embodiment, the chocolate composition of the present invention comprises at least 20% cocoa solids. In one embodiment, the chocolate composition of the present invention comprises at least 15% cocoa solids. In one embodiment, the chocolate composition of the present invention comprises at least 10% cocoa solids. In one embodiment, the chocolate composition of the present invention comprises at least 5% cocoa solids. In one embodiment, the chocolate composition of the present invention comprises at least 3% cocoa solids. In one embodiment, the chocolate composition of the present invention comprises 3 to 10% cocoa solids.

Suitable sweeteners include sugars (e.g. sucrose, dextrose, glucose syrup solids, fructose, lactose, maltose or any combination thereof), sugar alcohols (e.g. erythritol, sorbitol, xylitol, mannitol, lactitol, isomalt, or any combination thereof), intense sweeteners (e.g. aspartame, acesulfame-k, cyclamates, saccharin, sucralose, neohesperidin, dihydrochalone, alitame, stena sweeteners, glycyrrhizin or any combination thereof) and any combination of sugars, sugar alcohols and intense sweeteners. In one embodiment the sweetener is sugar. In one embodiment the sweetener is sucrose.

In one embodiment, the sweetener is present in the chocolate composition in an amount of from 35 to 65%. In one embodiment, the sweetener is present in the chocolate composition in an amount of from 40 to 60%. In one embodiment, the sweetener is present in the chocolate composition in an amount of from 45 to 55%. In one embodiment, the sweetener is present in the chocolate composition in an amount of from 45 to 50%. In one embodiment, the sweetener is present in the chocolate composition in an amount of from 45 to 47%. In one embodiment, the sweetener is present in the chocolate composition in an amount of about 46%.

In the context of the present invention, the fat content of dairy powder may vary depending on whether it is whole milk powder or skimmed milk powder. The dairy powder may be whole milk powder, skim milk powder, or a combination of dairy powders with different fat contents. In one embodiment, said dairy powder has a fat content of less than 30%. In one embodiment, said dairy powder has a fat content of less than 20%.

In one embodiment, such powder is present in an amount of at least 15%. In one embodiment, such powder is present in an amount of from 15 to 25%. In one embodiment, such powder is present in an amount of from 15 to 20%. In one embodiment, such powder is present in an amount of from 17 to 20%. In one embodiment, such powder is present in an amount of about 19%.

Suitable non-fat dairy solids include milk-solids-non-fat (MSNF). These may be included in suitable amounts as desired by one skilled in the art.

Suitable emulsifiers include lecithin derived from soya bean, safflower, sunflower, corn etc., fractionated lecithins enriched with either phosphatidyl choline, phosphatidyl ethanolamine, phosphatidyl inositol, mono- and diglycerides and their tartaric esters, monosodium phosphate derivatives of mono- and diglycerides of edible fats and oils, sorbitan monostearate, sorbitan tristearate, polyoxyethylene sorbitan monostearate, hydroxylated lecithin, synthetic phospholipids such as ammonium phosphatides, polyglycerol polyricinoleate (PGPR), lactylated fatty acid esters of glycerol and propylene glycol, polyglycerol esters of fatty acids, citric acid esters of fatty acids, propylene glycol mono- and diesters of fats and fatty acids.

In one embodiment, the chocolate composition of the present invention comprises emulsifier in an amount of about 2% or less. In one embodiment, the chocolate composition of the present invention comprises emulsifier in an amount of about 1.5% or less. In one embodiment, the chocolate composition of the present invention comprises emulsifier in an amount of about 1% or less. In one embodiment, the chocolate composition of the present invention comprises emulsifier in an amount of about 0.4 to 0.8%. In one embodiment, the chocolate composition of the present invention comprises emulsifier in an amount of about 0.6%. In one embodiment, the emulsifier is sorbitan tristearate (STS).

Suitable hydrocolloids include functional proteins such as, gelatin, myosin, sarcoplasmic proteins, albumens, and globulins; gums, such as, galactomannans, glucomannans, and microbials; gels, such as, seaweed extracts, pectinaceous materials, and konjacs; and other macromolecular entities such as, cellulosics, glucans, starches, and clays.

Hydrocolloids which may be added to the chocolate composition include, but are not limited to, acacia, acetan, acetylated distarch phosphate, acetylated starch, acid-thinned starch, adipic starch, agar (agar-agar), agaropectin, agarose, algin, alginate, alginic acid, amidated pectins, amorphophallus, amylopectin, amylopectin starch, amylose, arabic, arabica, arabinogalactan, arabogalactan, arracacha, arrowroot, beet pulp, beta glucan, bevo, British gum, cactus gum, carboxymethylethyl starches, carboxymethylcellulose, carboxymethylethylcellulose, carboxymethyl starch, cassia, chitin, chitosan, clay, collagen, combretum, curdlan, cydonia, Danish agar, dextran, dextrin, dulsan, distarch phosphate, ethylcellulose, ethylhydroxyethylcellulose, ethylmethylcellulose, eucheumas, ferlo, fibrinogen, flax seed, fucoidan, furcelleran, funoran, galactomannans, gatto, gelidium, gellan, ghatti, gigartinas, glucomannans, gluten, gracilarias, guluronics, gummifera, hashab, hemicelluloses, high amylose starch, hoblobo, hydrogenated starch, hydroxyalkylcellulose, hydroxyalkyl starch, hydroxyethylcellulose, hydroxyethylmethylcellulose, hydroxypropylcellulose, hydroxypropylmethylcellulos, hydroxypropyl starch, hypnean, iota carrageenan, iridaeans, isinglass, karaya, karroo, kelp, keltzan, konjac, kordofan, lakee, lambda carrageenan, laminaran, larch gum, linseed, locust bean, lupo, luposol, mannan, mannoglucuronoglycans, mannuronics, maracuya, mesquite, methylcellulose, microcrystalline cellulose, mucilage, mucin, mung bean, okra, oxidised starch, pea starch, pectic acid, plant exudates, potato pulp, potato starch, pregelatinized starches, propylated starch, propylene glycol alginate, prosopis seed, prosopis exudate, protopectins, prowashonupana barley, pullulan, psyllium, pyrodextrins, quince, quince seed, ramalin, rhamsam, St. Johns bread, salabreda, sandra beida, schizophyllan, scleroglycan, seaweed powders, semen cydonia, senna, seyal, sorghum, sterculia, suakim, succinoglycan, sunflower pectin, sunt, tahl, tahla, tamarind seed, tamarind kernel, taminda, tapioca, tara, tragacanth, undaria, verek, wattles, waxy maize, waxy rice, waxy sorghum, xyloglucan, yeast cell walls, and mixtures thereof.

In one embodiment, the chocolate composition of the present invention comprises hydrocolloid in an amount of about 12% or less. In one embodiment, the chocolate composition of the present invention comprises hydrocolloid in an amount of about 10% or less. In one embodiment, the chocolate composition of the present invention comprises hydrocolloid in an amount of about 7% or less. In one embodiment, the chocolate composition of the present invention comprises hydrocolloid in an amount of about 3% to 7%. In one embodiment, the chocolate composition of the present invention comprises hydrocolloid in an amount of about 5%. In one embodiment, the chocolate composition of the present invention comprises hydrocolloid in an amount of about 5% or less. In one embodiment, the hydrocolloid is microcrystalline cellulose.

Suitable flavourings may be natural and/or synthetic, especially those traditionally associated with chocolate, such as vanilla, orange and mint. Flavourings may also extend to additional additives such as nuts or fruit as commonly included in chocolate foodstuffs.

Thus, in a preferred embodiment, the dry ingredients of step i) are selected from cocoa solids, dairy powder, sugar, an emulsifier and/or a hydrocolloid. In a further preferred embodiment, the dry ingredients of step i) at least include cocoa solids, dairy powder and sugar. In a further preferred embodiment, the dry ingredients of step i) at least include cocoa solids, dairy powder, sugar and at least one of an emulsifier or a hydrocolloid. In a further preferred embodiment, the dry ingredients of step i) at least include cocoa solids, dairy powder, sugar, an emulsifier and a hydrocolloid.

In a further preferred embodiment, the dry ingredients of step i) at least include cocoa solids, dairy powder, sugar, sorbitan tristearate and microcrystalline cellulose.

In a further preferred embodiment, the dry ingredients of step i) at least include cocoa solids in an amount of at least 3%, dairy powder in an amount of at least 15%, sugar in an amount of from 35 to 65%, sorbitan tristearate in an amount of 2% or less and microcrystalline cellulose in an amount of 12% or less.

In one embodiment the dry ingredients of step i) have, as a whole, a particle size distribution (D₅₀) of 30 μm or less. Such a particle size distribution can be achieved by sieving or milling the relevant ingredients so that a particle size distribution (D₅₀) of the blend is 30 μm or less. In one embodiment, each dry ingredient is sieved prior to blending to ensure that it has a particle size distribution (D₅₀) of 30 μm or less.

In one embodiment a refining step can be added to the process. In one embodiment, the refining step can be performed following step iii). The step of refining can be performed as an alternative to sieving or milling the relevant ingredients to influence their particle size. Thus, when a refining step is included it may not be necessary to control the particle size distribution (D₅₀) of the dry ingredients of step i) to 30 μm or less. Avoiding a sieving or milling step may be seen as advantagoues from a process efficiency aspect. Accordingly, in one embodiment, the process comprises the following steps:
i) preparing a blend of dry ingredients, each ingredient having an individual fat content of less than 30%;
ii) conching the blend of dry ingredients;
iii) adding one or more ingredients having an individual fat content of 30% fat or greater to the blend and mixing;
iiia) refining the mixed blend of step iii); and
iv) compressing the mixture of step iiia) to form a chocolate composition.

However, it is also contemplated that the refining step can be performed in addition to a step, such as sieving or milling, to control the particle size distribution (D₅₀) of the dry ingredients of step i). Thus, in one embodiment, the process comprises the following steps:
i) preparing a blend of dry ingredients, each ingredient having an individual fat content of less than 30%;
ii) conching the blend of dry ingredients;
iii) adding one or more ingredients having an individual fat content of 30% fat or greater to the blend and mixing;
iiia) refining the mixed blend of step iii); and
v) compressing the mixture of step iiia) to form a chocolate composition.
wherein the dry ingredients of step i) have, as a whole, a particle size distribution (D₅₀) of 30 μm or less.

As mentioned above, such a particle size distribution can be achieved by sieving or milling the relevant ingredients so that a particle size distribution (D₅₀) of the blend is 30 μm or less.

In one embodiment, the refining step is typically carried out at a temperature in the range of about 15 to 35° C., preferably about 15 to 25° C., and most preferably at around 20° C. It is advantageous to conduct the refining step at a temperature that does not promote melting of the fat based ingredients. Suitable refining equipment is available, for example, a 3-roll mill SDY 200 from Buhler AG, Switzerland.

After the refining step (if present) a further step of mechanical processing may be performed so as to break up any larger collections of mixture particles formed during the refining process. Typically, the mechanical processing may be agitation, e.g gentle agitation.

As described above, once the blend of dry ingredients is prepared it is subjected to a conching step. Conching is known in the art to be a step of mixing at an elevated temperature, e.g. above room temperature, and need not be limited to fat based ingredients. In the context of the present invention the conching is carried out with respect to ingredients having an individual fat content of less than 30%, and thus conching can be carried out with respect to non-fat ingredients.

In one embodiment, the blend of dry ingredients is conched at a temperature of above 25° C. In one embodiment, the blend of dry ingredients is conched at a temperature of above 30° C. In one embodiment, the blend of dry ingredients is conched at a temperature of above 35° C. In one embodiment, the blend of dry ingredients is conched at a temperature of above 40° C. In one embodiment, the blend of dry ingredients is conched at a temperature of above 45° C. In one embodiment, the blend of dry ingredients is conched at a temperature of above 50° C. In one embodiment, the blend of dry ingredients is conched at a temperature of above 55° C. In one embodiment, the blend of dry ingredients is conched at a temperature of from 25 to 65° C. In one embodiment, the blend of dry ingredients is conched at a temperature of from 30 to 65° C. In one embodiment, the blend of dry ingredients is conched at a temperature of from 55 to 65° C. In one embodiment, the blend of dry ingredients is conched at a temperature of about 60° C.

In one embodiment, the blend of dry ingredients is conched for a period of at least 1 hour. In one embodiment, the blend of dry ingredients is conched for a period of at least 5 hours. In one embodiment, the blend of dry ingredients is conched for a period of at least 10 hours. In one embodiment, the blend of dry ingredients is conched for a period of at least 15 hours. In one embodiment, the blend of dry ingredients is conched for a period of at least 20 hours. In one embodiment, the blend of dry ingredients is conched for a period of from 1 to 25 hours. In one embodiment, the blend of dry ingredients is conched for a period of from 20 to 25 hours. In one embodiment, the blend of dry ingredients is conched for a period of about 23 hours.

In one embodiment, the blend of dry ingredients is conched for a period of from 20 to 25 hours at a temperature of from 55 to 65° C. In one embodiment, the blend of dry ingredients is conched for a period of about 23 hours at a temperature of about 60° C.

As described above, following conching, one or more ingredients having an individual fat content of 30% fat or greater is added to the conched blend and mixed. In one embodiment, the conched composition is allowed to cool to ambient temperature before the further ingredients are added.

In one embodiment, the one or more ingredients having an individual fat content of 30% fat or greater is cocoa butter and/or a cocoa butter substitute/replacer.

In one embodiment, the one or more ingredients having an individual fat content of 30% fat or greater includes cocoa butter. In one embodiment, the one or more ingredients having an individual fat content of 30% fat or greater includes a cocoa butter substitute/replacer. In one embodiment, the one or more ingredients having an individual fat content of 30% fat or greater is cocoa butter and a cocoa butter substitute and/or replacer.

In this regard, said one or more ingredients having an individual fat content of 30% fat or greater can be considered to be the predominant fat component of the chocolate composition. However, it is noted that a small proportion of the total fat may be contributed from the dry ingredients included in step i).

In one embodiment, the chocolate composition of the present invention comprises at least 20% fat in total. In one embodiment, the chocolate composition of the present invention comprises at least 25% fat in total. In one embodiment, the chocolate composition of the present invention comprises at least 27% fat in total. In one embodiment, the chocolate composition of the present invention comprises from 20 to 35% fat in total. In one embodiment, the chocolate composition of the present invention comprises from 20 to 30% fat in total. In one embodiment, the chocolate composition of the present invention comprises from 25 to 30% fat in total. In one embodiment, the chocolate composition of the present invention comprises about 30% fat in total.

In one embodiment, the one or more ingredients having an individual fat content of 30% fat or greater is predominantly cocoa butter substitute/replacer.

In one embodiment, the fat present in the chocolate composition is at least 50% cocoa butter substitute/replacer. In one embodiment, the fat present in the chocolate composition is at least 55% cocoa butter substitute/replacer. In one embodiment, the fat present in the chocolate composition is at least 60% cocoa butter substitute/replacer. In one embodiment, the fat present in the chocolate composition is at least 65% cocoa butter substitute/replacer. In one embodiment, the fat present in the chocolate composition is at least 70% cocoa butter substitute/replacer. In one embodiment, the fat present in the chocolate composition is at least 75% cocoa butter substitute/replacer. In one embodiment, the fat present in the chocolate composition is at least 80% cocoa butter substitute/replacer. In one embodiment, the fat present in the chocolate composition is at least 85% cocoa butter substitute/replacer. In one embodiment, the fat present in the chocolate composition is at least 90% cocoa butter substitute/replacer. In one embodiment, the fat present in the chocolate composition is at least 95% cocoa butter substitute/replacer. In one embodiment, the fat present in the chocolate composition is at least 98% cocoa butter substitute/replacer.

Thus, in one embodiment, the chocolate composition comprises cocoa butter substitute/replacer in an amount of at least 10% based on the total weight of the composition. In one embodiment, the chocolate composition comprises cocoa butter substitute/replacer in an amount of at least 15% based on the total weight of the composition. In one embodiment, the chocolate composition comprises cocoa butter substitute/replacer in an amount of at least 18% based on the total weight of the composition. In one embodiment, the chocolate composition comprises cocoa butter substitute/replacer in an amount of at least 20% based on the total weight of the composition.

Suitable cocoa butter substitutes (CBSs) include CBS laurics, such as CEBES™ (available from AAK, Jungmansgatan 12, SE-211 19 Malmo, Sweden) and CBS non-laurics. CBS laurics are short-chain fatty acid glycerides. Their physical properties vary within the group but they all have triglyceride configurations that make them compatible with cocoa butter. Suitable CBS laurics include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS non-laurics include soya, cottonseed, peanut, rapeseed and corn (maize) oil. However, the present invention is not limited to the particular cocoa butter substitutes/replacers mentioned above and the skilled person will be aware of other suitable cocoa butter substitutes/replacers.

The cocoa butter substitutes may comprise one or more of the above mentioned emulsifiers in the above mentioned amounts.

In one embodiment, the one or more ingredients having an individual fat content of 30% fat or greater is a cocoa butter substitute, in particular a vegetable triglyceride.

In one embodiment, the one or more ingredients having an individual fat content of 30% fat or greater is selected from one or more cocoa butter substitutes/replacers and a minor amount of cocoa butter.

In a particular embodiment the fat of the chocolate composition comprises no more than 2% or no more than 1% cocoa butter.

Thus, in one embodiment, the chocolate composition comprises 2% or less cocoa butter. In one embodiment, the chocolate composition comprises 1.5% or less cocoa butter. In one embodiment, the chocolate composition comprises 1% or less cocoa butter.

The one or more ingredients having an individual fat content of 30% fat or greater may be added in any suitable form. In one embodiment, said ingredients are added as a powder. In one embodiment, said ingredients are spray crystallised. In one embodiment, the one or more ingredients having an individual fat content of 30% fat or greater is a spray crystallised vegetable triglyceride.

Once the one or more ingredients having an individual fat content of 30% fat or greater are added to the conched blend, the resulting mixture is mixed. Mixing is performed until the fat is uniformly dispersed. In one embodiment, mixing is carried out for at least 30 minutes. In one embodiment, mixing is carried out for at least 1 hour. In one embodiment, mixing is carried out for at least 2 hours.

It is to be noted that a tempering step is not required. As explained above, tempering is a process whereby the chocolate is heated and cooled to specific temperatures to ensure that the fats present in the chocolate crystalize in a desired form. In one embodiment, the process does not include a tempering step. However, although not required, a tempering step is not excluded from the process of the present invention. In one embodiment, a tempering step may be performed following compression. If required, tempering may be carried out at, for example, around 40° C.

Without wishing to be bound by theory, the advantageous properties of the chocolate composition produced by the process of the present invention may be related to the fact that the chocolate composition is not prepared such that the fat is the continuous element. Rather, the fat is dispersed within a continuous powder and thus the structure of the chocolate composition may be less vulnerable to fat phase changes etc.

As described above, following the addition and mixture of the one or more ingredients having an individual fat content of 30% fat or greater the resulting mixture is compressed to form the chocolate composition.

In this regard, compression refers to the application of sufficient pressure to the mixed ingredients so as to form a chocolate composition that is solid, or substantially solid. In one embodiment, the mixture of step iii) is compressed at a compression pressure of up to about 34 kN/cm². In one embodiment, the mixture of step iii) is compressed at a compression pressure of from about 8.0 to 24.0 kN/cm². In one embodiment, the mixture of step iii) is compressed at a compression pressure of from about 9.0 to 23.0 kN/cm². In one embodiment, the mixture of step iii) is compressed at a compression pressure of from about 9.6 to 22.6 kN/cm². In one embodiment, the mixture of step iii) is compressed at a compression pressure of from about 9.0 to 12.0 kN/cm². In one embodiment, the mixture of step iii) is compressed at a compression pressure of from about 12.0 to 16.0 kN/cm². In one embodiment, the mixture of step iii) is compressed at a compression pressure of from about 16.0 to 19.0 kN/cm². In one embodiment, the mixture of step iii) is compressed at a compression pressure of from about 19.0 to 23.0 kN/cm².

Compression is conducted using any suitable machine in the art, for example, a Piccola rotary tablet press with a pre-compression system (available from Riva, Aldershot, Hampshire, UK).

The compression pressure may be varied depending on the thickness of the chocolate composition. For thicker tablets, less compression pressure may be required.

The period of compression is not particularly limited. Indeed, in one embodiment compression is performed for about 1 to 10 seconds. However, compression may be performed for a longer period of time (minutes).

The compressed chocolate composition may be referred to as a tablet.

Once compressed and formed, the chocolate composition may be subjected to further optional steps.

In one embodiment, the compressed chocolate composition is packaged. Thus, the present invention also relates to a packaged chocolate composition wherein the composition is defined and obtainable/obtained as described herein.

In one embodiment, the compressed chocolate composition is subjected to heat treatment. In this regard, the compressed chocolate composition is heated to about 40 to 50° C. and then allowed to return to ambient temperature. In one embodiment, the compressed chocolate composition is heated to about 45° C. and then allowed to return to ambient temperature.

In one embodiment, the compressed chocolate composition is heated to about 40° C. and then allowed to return to ambient temperature. In one embodiment, the above heat treatment is performed for at least 10 minutes. In one embodiment, the above heat treatment is performed for at least 30 minutes. In one embodiment, the above heat treatment is performed for at least 60 minutes. In one embodiment, the above heat treatment is performed for at least 2 hours minutes. In one embodiment, the above heat treatment is performed for from 2 hours to 30 hours. In one embodiment, the above heat treatment is performed for from 20 hours to 34 hours. In one embodiment, the above heat treatment is performed for around 24 hours.

The present invention will now be described with reference to the following non-limiting examples.

### EXAMPLES

### Example 1

Chocolate compositions were formulated according to the following recipes.

| Recipe No 1 | % |
|---|---|
| Fat (PS 101 from DuPont | 29.4 |
| Nutrition Biosciences ApS) | |
| Whole milk powder | 9.2 |
| Cocoa powder (10-12% fat) | 5.0 |
| Icing sugar | 46.2 |
| Skim milk powder | 10.2 |

| Recipe No 2 | % |
|---|---|
| Fat (Cebes ™ 80 from AAK) | 29.4 |
| Whole milk powder | 9.2 |
| Cocoa powder (10-12% fat) | 5.0 |
| Icing sugar | 46.2 |
| Skim milk powder | 10.2 |

| Recipe No 3 | % |
|---|---|
| Fat (Cebes ™ 80 from AAK - 97%; PS | 29.4 |
| 209 from DuPont Nutrition | |
| Biosciences ApS 3%) | |
| Whole milk powder | 9.2 |
| Cocoa powder (10-12% fat) | 5.0 |
| Icing sugar | 46.2 |
| Skim milk powder | 10.2 |

| Recipe No 4 | % |
|---|---|
| Fat (Cebes ™ 80 from AAK) | 29.4 |
| Whole milk powder | 9.2 |
| Cocoa powder (10-12% fat) | 5.0 |
| Icing sugar | 36.2 |
| Skim milk powder | 10.2 |
| MCC 17LS (from DuPont Nutrition | 10.0 |
| Biosciences ApS) | |

| Recipe No 5 | % |
|---|---|
| Fat (Cebes ™ 80 from AAK) | 29.4 |
| Whole milk powder | 9.2 |
| Cocoa powder (10-12% fat) | 5.0 |
| Icing sugar | 41.2 |
| Skim milk powder | 10.2 |
| MCC 17LS (from DuPont Nutrition | 5.0 |
| Biosciences ApS) | |

| Recipe No 6 | % |
|---|---|
| Fat (Cebes ™ 80 from AAK) | 29.4 |
| Whole milk powder | 0 |
| Cocoa powder (10-12% fat) | 5.0 |
| Icing sugar | 46.2 |
| Skim milk powder | 19.4 |

The following ingredients were mixed (according to step i) of the present invention) and then heated to 60° C. for 23 hours while stirring (conched):
whole milk powder;
cocoa powder;
skim milk powder;
sugar; and
MCC 17 LS (where appropriate).

The blend was subsequently allowed to cool to ambient temperature before mixing in the ingredients with a fat content of 30% fat or greater.

The resulting mixture (a powder) was compressed into tablets (diameter approx. 12 mm; height approx. 6-8 mm high for Trials 1 to 11 and 12-18 mm high for Trials 12 to 17) using a Piccola rotary tablet press with a pre-compression system (available from Riva, Aldershot, Hampshire, UK). A compression pressure in the range 9.6 to 22.6 kN/cm² was applied.

Chocolate compositions (tablets) that were subsequently heat treated were treated at 40° C. for approx. 24 hours and cooled to ambient temperature.

Trials 1 to 9 did not include a conching step.

For trials 6, 7 and 17 the sugar and skim milk powder were sieved to remove the larger particles. Sieving was done on an Alpine wind sifter (HOSOKAWA ALPINE AG) equipped with a Haver & Boecker USA Standard Test Sieve 325 mesh operating with vacuum for 6 min.

TABLE 1

| | | | | | Heat | |
|---|---|---|---|---|---|---|
| Trial | Recipe | Conched | Sieved | Additive | treatment | Results |
| 1 | 1 | No | No | | | Grainy |
| 2 | 1 | No | No | | | Grainy |
| 3 | 1 | No | No | | | Grainy |
| 4 | 1 | No | No | | | Grainy |
| 5 | 1 | No | No | | | Grainy |
| 6 | 6 | No | Yes | | | Not grainy |
| 7 | 1 | No | Yes | | | Not grainy |
| 8 | 2 | No | No | | | Grainy |
| 9 | 3 | No | No | | | Grainy |
| 10 | 2 | Yes | No | | | Grainy |
| 11 | 3 | Yes | No | | | Grainy |
| 12 | 2 | Yes | No | | Yes | Grainy |
| 13 | 5 | Yes | No | 5% MCC | Yes | Grainy |
| | | | | 11LS | | |
| 14 | 4 | Yes | No | 10% | Yes | Grainy |
| | | | | MCC | | |
| | | | | 11LS | | |
| 15 | 5 | Yes | No | 5% MCC | Yes | Grainy |
| | | | | 17LS | | |
| 16 | 4 | Yes | No | 10% | Yes | Grainy |
| | | | | MCC | | |
| | | | | 17LS | | |
| 17 | 2 | Yes | Yes | 10% | Yes | Not grainy |
| | | | | MCC | | |
| | | | | 17LS | | |

PS 109 was cryo-crystallised; Cebes™ 80 was spray-crystallised.

The above trials resulted in chocolate compositions with a noticeable snap at room temperature, a good melting profile with good taste release. The chocolate compositions maintained their shape and form after being exposed to elevated temperature (50° C. for 4 weeks). Without being bound by theory, it is considered that the separate addition of the predominantly fat based ingredients to the ingredient mix and the resulting compression step leads to the chocolate “tablets” with a noticeable snap at room temperature, a good melting profile with good taste release.

Sieving of the ingredients resulted in an improvement in the mouthfeel of the chocolate composition.

Heat treating the tablets resulted in the tablets becoming darker which was considered to be an improvement.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the following claims

1. A process for the preparation of a chocolate composition, the process comprising the steps of:
i) preparing a blend of dry ingredients, each ingredient having an individual fat content of less than 30%;
ii) conching the blend of dry ingredients;
iii) adding an ingredient having an individual fat content of 30% fat or greater to the blend and mixing; and
iv) compressing the mixture of step iii) to form the chocolate composition.

2. The process according to claim 1 wherein the conching is carried out at 40° C. to 65° C. for at least 30 minutes.

3. The process according to claim 1, wherein the ingredients of step i) comprise an ingredient selected from cocoa solids, dairy powders, sweeteners, emulsifiers, milk-solids-non-fats (MSNF), flavourings, preservatives, and other excipients.

4. The process according to claim 3 wherein:
the ingredients of step i) comprise an emulsifier; and
the emulsifier is selected from the group consisting of lecithins enriched in either phosphatidyl choline or phosphatidyl ethanolamine or both, mono-and diglycerides, diacetyl tartaric acid esters of mono-and diglycerides, monosodium phosphate derivatives of mono- and diglycerides of edible fats or oils, sorbitan monostearate, sorbitan tristearate, polyoxyethylene sorbitan monostearate, hydroxylated lecithin, lactylated fatty acid esters of glycerol and propylene glycol, polyglycerol esters of fatty acids, propylene glycol mono-and diester of fats, ammonium salts of phosphatidic acid, and sucrose esters.

5. The process according claim 3 wherein the ingredients of step i) comprise a hydrocolloid.

6. The process according claim 5 wherein the hydrocolloid is microcrystalline cellulose.

7. The process according to claim 1 wherein the ingredient having an individual fat content of 30% fat or greater is selected from cocoa butter, cocoa butter substitutes and cocoa butter replacers.

8. The process according to claim 7 wherein the ingredient having an individual fat content of 30% fat or greater comprises a vegetable triglyceride.

9. The process according to claim 1 wherein the ingredient having an individual fat content of 30% fat or greater is spray crystallised.

10. The process according to claim 1 wherein the blend of dry ingredients of step i) has a particle size distribution (D₅₀) of about 30 μm or less.

11. The process according to claim 1 wherein the ingredients blended in step i) are refined, either individually or together, prior to blending.

12. The process according to claim 11 wherein the refining includes milling and/or sieving.

13. The process according to claim 1 wherein the formed chocolate composition is additionally subjected to heat treatment for a period of at least 10 minutes.

14. The process according to claim 13 wherein the heat treatment is carried out at a temperature of about 40 to 50° C. and then allowed to return to ambient temperature.

15. The process according to claim 1, the process comprising the steps of:
i) preparing a blend of dry ingredients, each ingredient having an individual fat content of less than 30%;
ii) conching the blend of dry ingredients;
iii) adding an ingredient having an individual fat content of 30% fat or greater to the blend and mixing;
iiia) refining the mixed blend of step iii); and
iv) compressing the mixture of step iiia) to form the chocolate composition.

16. The process according to claim 15, wherein the refined mixture of step iiia) is subjected to agitation.

17. A chocolate composition obtained or obtainable according to the process of claim 1.

18. A packaged chocolate composition, wherein the chocolate composition is as defined in claim 17.

19. The process according to claim 1, wherein step iii) comprises adding more than one ingredient having an individual fat content of 30% fat or greater to the blend and mixing.

20. The process according to claim 19 wherein the ingredients having an individual fat content of 30% fat or greater are spray crystallised.
